(19) United States
(12) Patent Application Publication
(10) Pub. No.: US 2008/0231952 A1
(43) Pub. Date: Sep. 25, 2008

(54) HIGHLY EFFICIENT 2D/3D SWITCHABLE DISPLAY DEVICE

(75) Inventor: Dae-sik KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/863,541

(22) Filed: Sep. 28, 2007

(30) Foreign Application Priority Data
Mar. 21, 2007 (KR) 10-2007-0027809

(51) Int. Cl. G02B 27/26

(52) U.S. Cl. 359/465

(57) ABSTRACT

Provided is a high efficient 2-dimensional (2D)/3-dimensional (3D) switchable display device including: a light source unit; a first reflective polarizer reflecting a first polarized light beam and transmitting a second polarized light beam orthogonal to the first polarized light beam from among light beams irradiated from the light source unit; a switching parallax barrier unit controlled in one of 2D and 3D modes, wherein, in the 2D mode, the switching parallax barrier unit wholly transmits the light beams having passed the first reflective polarizer, and, in the 3D mode, an area of the switching parallax barrier unit transmits the light beams and an area of the switching parallax barrier unit intercepts the light beams; and a display panel modulating light, that is transmitted through the switching parallax barrier unit, according to an image signal, to form an image.

### CROSS-REFERENCE TO RELATED PATENT APPLICATION

This application claims priority from Korean Patent Application No. 10-2007-0027809, filed on Mar. 21, 2007, in the Korean Intellectual Property Office, the disclosure of which is incorporated herein in its entirety by reference.

### BACKGROUND OF THE INVENTION

1. Field of the Invention

The present invention relates to a 2-dimensional (2D)/3-dimensional (3D) image display device, and more particularly, to a 2D/3D image display device capable of minimizing light loss occurring when a 2D display is switched to a 3D display.

2. Description of the Related Art

Stereoscopic image display devices have been used in various fields including medical imaging, games, advertisements, education, military applications, etc. Holographic and stereoscopic methods have been widely studied to display stereoscopic images.

The holographic method is a good display method but requires a coherent light source, and thus it is difficult to record and reproduce a large object positioned at a long distance.

The stereoscopic method employs a stereoscopic effect caused by a binocular parallax between two 2D images that are respectively seen by the two eyes of a viewer in order to produce a 3D effect. The stereoscopic method uses two planar images and thus can display a 3D image which is easily realized and has high resolution and great depth. The stereoscopic method is classified into a glasses-type image display method, in which polarized light and a shutter are used to allow two eyes to see separate images, and a glassesless-type autostereoscopic image method, in which a display directly separates images to form a visual field. In the glassesless-type autostereoscopic image display method, an observation range is fixed and limited to a smaller number of viewers. However, the glassesless-type autostereoscopic image display method is generally preferred to the glasses-type image display method in which the viewers must wear glasses. Additionally, a parallax barrier is increasingly used as a method of virtually realizing a 3D image using a stereo image. In the parallax barrier, a vertical or horizontal slit is placed in front of images corresponding to the left and right eyes to dividedly observe a stereo image synthesized by the vertical or horizontal slit so as to produce a 3D effect.

FIG. 1 schematically illustrates a conventional parallax barrier type stereoscopic image display device. Referring to FIG. 1, left eye pixels L displaying left eye image information and right eye pixels R displaying right eye image information are alternately formed on a liquid crystal display (LCD) panel 10. A backlight 20 is positioned under the LCD panel 10. The backlight 20 irradiates light toward the LCD panel 10 using electrical energy. A parallax barrier 30 is positioned between the LCD panel 10 and an observer 40 to allow light to pass or intercept light. In other words, the parallax barrier 30 includes slits 32 passing light transmitted from the right eye pixels R and the left eye pixels L and barriers 34 intercepting the light so as to realize a 3D image to the observer 40. As shown in an enlarged view of the parallax barrier 30, the slits 32 and the barriers 34 are vertically alternately formed.

A method of realizing a 3D image using such a parallax barrier will now be described. Light beams, which are irradiated from the backlight 20 and advance toward a left eye of the observer 40, are light beams L1 which pass through the left eye pixels L of the LCD panel 10 and the slits 32 of the parallax barrier 30 and then reach the left eye of the observer 40. However, light beams L2, which are irradiated from the backlight 20, pass through the left eye pixels L of the LCD panel 10, and advance toward a right eye of the observer 40, are intercepted by the barriers 34 and thus are not transmitted to the observer 40. Light beams R1 are irradiated from the backlight 20, pass through the right eye pixels R of the LCD panel 10 and the slits 32 of the parallax barrier 30, and reach the right eye of the observer 40. Light beams R2, which pass through the right eye pixels R of the LCD panel 10 and advance toward the left eye of the observer 40, are intercepted by the barriers 34. As a result, the light beams L1, which have passed through the left eye pixels L, reach only the left eye of the observer 40, and the light beams R1, which have passed the right eye pixels L, reach only the right eye of the observer 40. Binocular parallax information is formed between the light beams L1, which reach the left eye so as to be sufficiently perceived by a human observer, and the light beams R1, which reach the right eye. As a result, the observer can view a 3D image.

A 2D/3D switchable display uses a 3D LCD display to realize a parallax barrier and prevent viewer's fatigue occurring when using optical illusions of both eyes. In this case, for example, each region of the parallax barrier 30 of FIG. 1 is construed using liquid crystals (LC). When power is applied to regions of the LC, the regions intercept and/or absorb light emitted from the backlight 20 to operate as the barriers 34. The regions of the LC to which power is not applied operate as the slits 32 of the parallax barrier 30 to realize a stereo image. Also, when power is not applied to the LC, the parallax barrier is not formed. Thus, the same image is transmitted to right and left eyes of a viewer to display a 2D image.

In a method of using a parallax barrier, a large amount of light is intercepted by and absorbed into barriers due to a display of a stereo image. Thus, light efficiency is lower. It is difficult to minimize a size of slit in order to reduce crosstalk in a 3D mode. Also, an amount of light intercepted by the barriers is increased with an increase of a number of visual points and light efficiency is increasingly reduced. As a result, the 2D/3D switchable display is difficult to be used in a multi-mode.

FIG. 2 illustrates a structure of a parallax barrier type stereoscopic image display device for improving light efficiency. Referring to FIG. 2, aluminum coatings 66 are formed on barriers 63, which absorb light irradiated from a backlight 60, in order to reflect the light toward a reflector 69 so as to recycle the light. However, this structure enables a 3D display only and disables 2D/3D switching.

### SUMMARY OF THE INVENTION

The present invention provides a highly efficient 2-dimensional (2D)/3-dimensional (3D) switchable display device for limiting reduction of light efficiency in a 3-dimensional mode.

According to an aspect of the present invention, there is provided a 2D/3D switchable display device including: a light source unit; a first reflective polarizer reflecting a first polarized light beam and transmitting a second polarized light beam orthogonal to the first polarized light beam from among light beams irradiated from the light source unit; a switching parallax barrier unit controlled in one of 2D and 3D modes, wherein, in the 2D mode, the switching parallax barrier unit wholly transmits the light beams having passed through the first reflective polarizer, and, in the 3D mode, an area of the switching parallax barrier unit transmits the light beams and an area of the switching parallax barrier unit intercepts the light beams; and a display panel modulating light, that is transmitted through the switching parallax barrier unit, according to an image signal, to form an image.

The switching parallax barrier unit may include: a polarization switch array, comprising polarization switch areas, which is controlled to switch the second polarized light beams, having passed through the first reflective polarizer, to the first polarized light beams, or, to maintain their polarization states, and slit areas, which transmit the second polarized light beams maintaining their polarization states, wherein the polarization switch areas and the slit areas are alternately arrayed; and a second reflective polarizer reflecting the first polarized light beams and transmitting the second polarized light beams.

The polarization switch areas may delay a phase of incident light having a wavelength λ by 0, +λ/2, or −λ/2 according to an electrical signal.

The first and second reflective polarizers may be wire grid polarizers or double brightness enhancement films (DBEFs).

The polarization switch array may have a strip shape, a slanted strip shape, a 2D arrayed shape, or a pin hole shape in which the polarization switch areas and the slit areas are alternately arrayed.

The light source unit may include a reflector which recycles light reflected from the first or second reflective polarizer.

### BRIEF DESCRIPTION OF THE DRAWINGS

The above and other aspects of the present invention will become more apparent by describing in detail exemplary embodiments thereof with reference to the attached drawings in which:

FIG. 1 schematically illustrates a conventional stereoscopic image display using a parallax barrier;

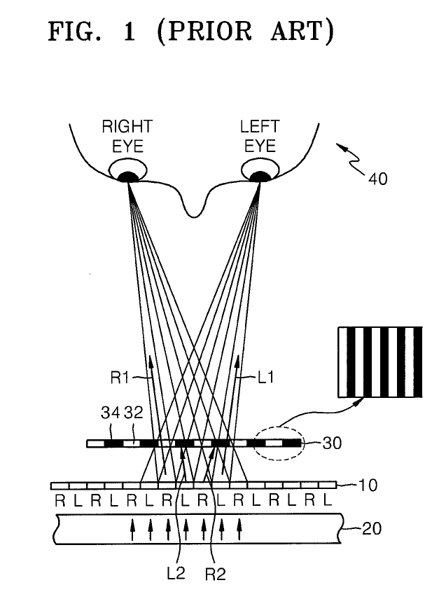

FIG. 2 illustrates a structure of a conventional parallax barrier type stereoscopic image display device for improving light efficiency;

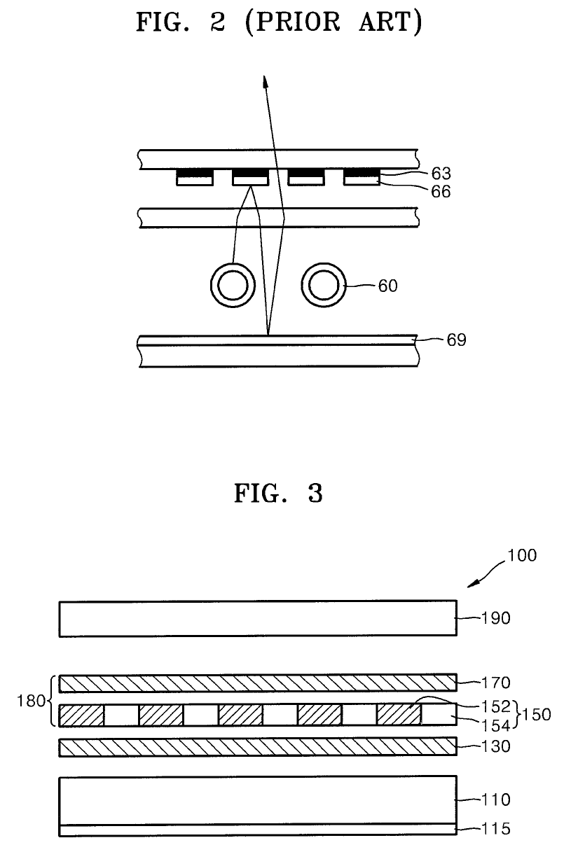

FIG. 3 is a schematic cross-sectional view of a 2D/3D switchable display device according to an exemplary embodiment of the present invention;

FIGS. 4A through 4D illustrate array shapes of a polarization switch array of the 2D/3D switchable display device of FIG. 3, in which polarization switch areas and slit areas are arranged alternately according to an exemplary embodiment of the present invention;

FIG. 5 illustrates a wire grid polarizer used as a reflective polarizer according to an exemplary embodiment of the present invention;

FIG. 6 is a graph illustrating a polarization extinction ratio of the wire grid polarizer of FIG. 5; and

FIGS. 7A and 7B illustrate optical paths through which the 2D/3D switchable display device of FIG. 2 operates in 2D and 3D modes.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. In the drawings, the thicknesses of layers and regions are exaggerated for clarity.

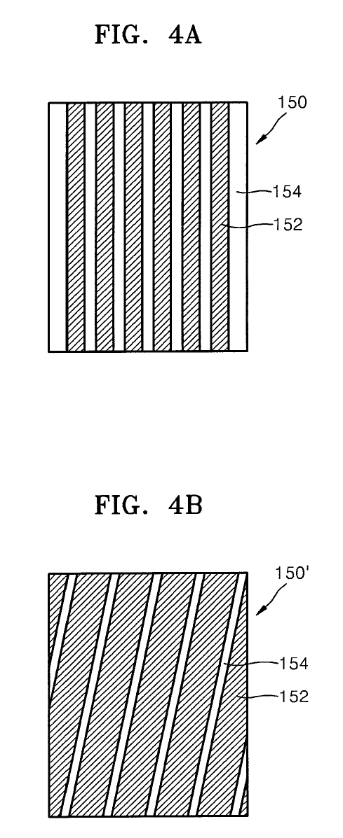

FIG. 3 is a schematic cross-sectional view of a 2D/3D switchable display device 100 according to an exemplary embodiment of the present invention. Referring to FIG. 3, a 2D/3D switchable display device 100 includes a light source unit 110, a first reflective polarizer 130, a switching parallax barrier unit 180 which is controlled in a 2D or 3D mode, and a display panel 190.

The light source unit 110 may include a reflector 115 to recycle light reflected from the first reflective polarizer 130 or the switching parallax barrier unit 180.

The first reflective polarizer 130 transmits a first polarized light beam among non-polarized light beams irradiated from the light source unit 110 and reflects a second polarized light beam orthogonal to the first polarized light beam. For example, the first polarized light beam may be an S polarized light beam, and the second polarized light beam may be a P polarized light beam. The first reflective polarizer 130 may be a double brightness enhancement film (DBEF) or a wire grid polarizer.

The switching parallax barrier unit 180 is controlled in the 2D or 3D mode. The switching parallax barrier unit 180 fully transmits incident light in the 2D mode. However, in the 3D mode, the switching parallax barrier unit 180 transmits light in some areas but intercepts light in other areas. For this purpose, the switching parallax barrier unit 180 may include a polarization switch array 150 and a second reflective polarizer 170.

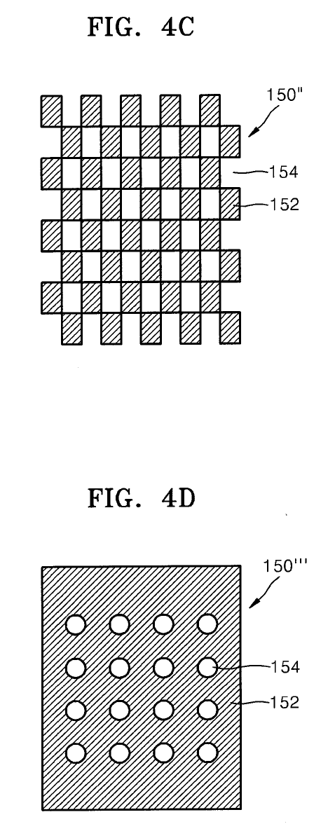

The polarization switch array 150 includes a plurality of polarization switch areas 152 and a plurality of slit areas 154 which are alternately arrayed. The polarization switch areas 152 may be phase retarders which delay a phase of incident light having a wavelength λ by 0, +λ/2, or −λ/2 according to an electrical signal. In other words, the polarization switch areas 152 switch polarization of incident light to orthogonal polarization or maintain the polarization of the incident light and transmit the incident light. The slit areas 154 do not change a polarization state of the incident light but transmit the incident light and thus may be formed of a light transmissive material formed of an optical isotropic material or an opening. The polarization switch array 150 will be described in more detail later with reference to FIGS. 4A through 4D. The polarization switch array 150 may have a strip shape 150, a slanted stripe shape 150′, a 2D array shape 150″, or a pin hole shape 150′″ as shown in FIGS. 4A through 4D. In the strip shape 150 shown in FIG. 4A, the polarization switch areas 152 and the slit areas 154 having a vertical stripe shape are alternately arranged in a horizontal direction. In the slanted stripe shape 150′ shown in FIG. 4B, the polarization switch areas 152 and the slit areas 154 having slanted stripe shapes are alternately arranged in a horizontal direction. In the 2D arrayed shape 150″ shown in FIG. 4C, the polarization switch areas 152 and the slit areas 154 are 2-dimensionally arrayed in zigzags. In the pin hole shape 150′″ shown in FIG. 4D, the slit areas 154 are pin holes.

The second reflective polarizer 170 transmits the first polarized light beam which has passed the polarization switch array 150 and reflects the second polarized light beam orthogonal to the first polarized light beam. The reflective polarizer 170 may be a DBEF or a wire grid polarizer.

The display panel 190 modulates a light beam having passed the switching parallax barrier unit 180 according to an image signal to form an image. The display panel 190 may be a liquid crystal display (LCD) panel. The display panel 190 may alternately display left and right eye images, e.g., left eye image pixels and right eye image pixels in alternating columns, in a 3D mode. Also, if a multiview stereo image is provided, the display panel 190 may alternately display multiview images with pixels of each column.

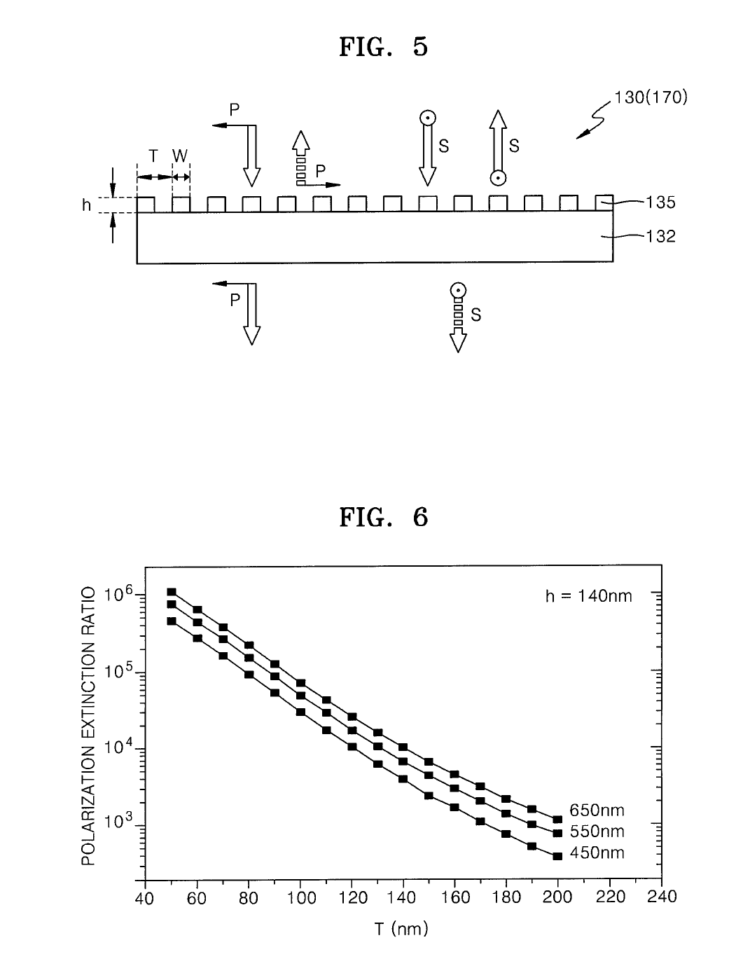

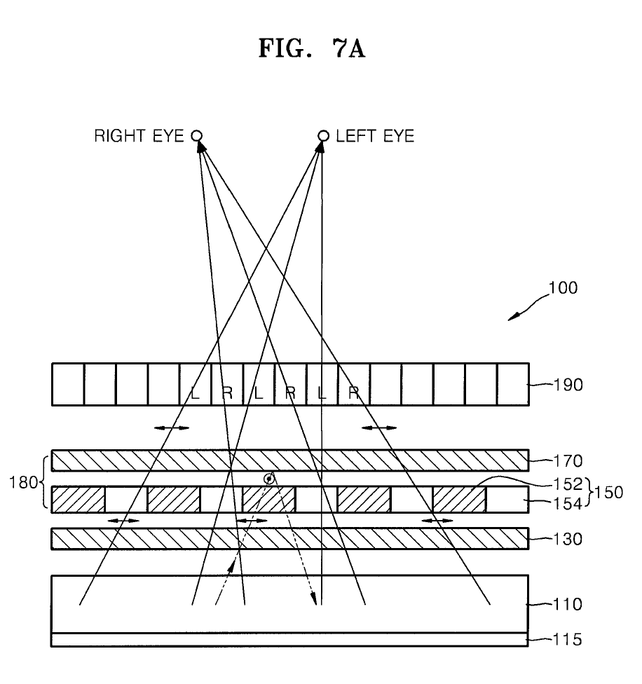

FIG. 5 illustrates a schematic structure of a wire grid polarizer which may be used as the first or second reflective polarizer 130 or 170. Referring to FIG. 5, the wire grid polarizer has a structure in which a plurality of metal wires 135 are periodically arrayed on a transparent substrate 132. If a spatial period T of the metal wires 135 is smaller than λ/2, the wire grid polarizer reflects a first polarized light beam S polarized in a lengthwise direction of the metal wires 135 and transmits a second polarized light beam P polarized in a widthwise direction W of the metal wires 135. In other words, the metal wires 135 show high reflection metal characteristics with respect to the first polarized light beam S. Although the metal wires 135 are formed of a reflective metal, the metal wires 135 absorb a small amount of light. Also, if the metal wires 135 have thin thicknesses, the metal wires 135 may transmit a few light beams. Thus, a reflectance is within a range between 90% and 95%. The transmitted light beams are indicated with dotted arrows. The second polarized light beam P. i.e., a light beam parallel with the widthwise direction of the metal wires 135, mostly transmits through the wire grid polarizer. However, although the wire grid polarizer is transparent like glass, a few light beams are reflected from a surface of the wire grid polarizer as indicated with dotted arrows. The metal wires 135 may be formed of a metal material having high reflectance. For example, the metal wires 135 may be formed of aluminum (Al), gold (Au), or silver (Ag). The detailed shape and dimension of the wire grid polarizer, e.g., the spatial period T, a height H, a width W, etc. of the metal wires 135, are appropriately designed in consideration of the material of the metal wires 135 and a wavelength λ of incident light. For example, the height h of the metal wires 135 is high enough so that the metal wires 135 operate as reflective metals with respect to light beams polarized in the lengthwise direction of the metal wires 135. Also, the width W of the metal wires 135 is shorter than the wavelength λ of the light incident onto the wire grid polarizer. A performance of the wire grid polarizer may be represented by a polarization extinction ratio and a transmittance. The polarization extinction ratio is defined as “(Sᵢ/Sₜ)|_{Pi=0},” and the transmittance is defined as “(Pₜ/Pᵢ)|_{Si=0}.” In other words, the polarization extinction ratio indicates an optical power ratio of an incident S polarized light beam Sᵢ to a transmitted S polarized light beam Sₜ if a S polarized light beam is incident. The transmittance indicates an optical power ratio of a transmitted P polarized light beam Pₜ to an incident P polarized light beam Pᵢ if a P polarized light beam is incident. FIG. 6 is a graph illustrating the polarization extinction ratio of the wire grid polarizer with respect to spatial period T, for various wavelengths. Referring to FIG. 6, the polarization extinction ratio has a higher value when T is short. Here, the metal wires 135 were formed of Al at the height h of 140 nm. When the polarization extinction ratio is high, high-quality polarized light can be provided to a display panel. Thus, a detailed design dimension of the wire grid polarizer can be adjusted in consideration of the polarization extinction ratio.

An operation of the 2D/3D switchable display device 100 forming 2D and 3D images will now be described.

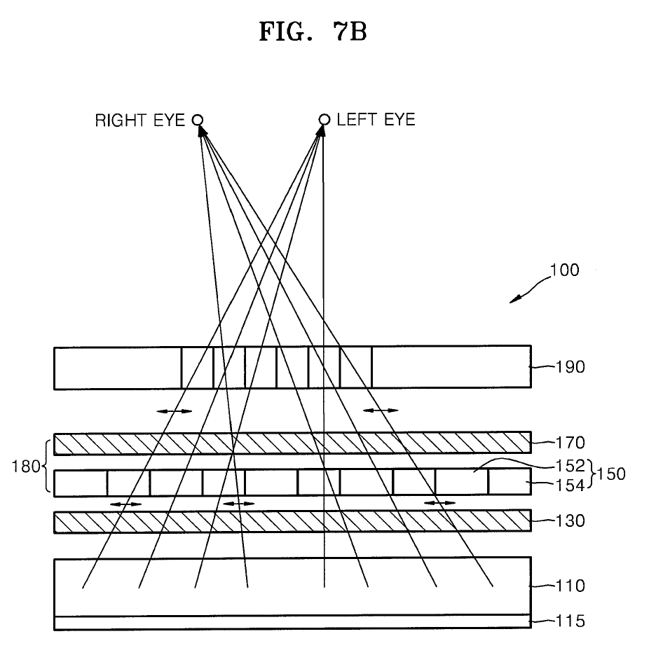

FIGS. 7A and 7B illustrate optical paths through which the 2D/3D switchable display device 100 operates in 2D and 3D modes.

Referring to FIG. 7A, only linearly polarized light beams in a predetermined direction among arbitrarily polarized light beams which are irradiated from the light source unit 110 toward the first reflective polarizer 130, transmit through the first reflective polarizer 130, while other polarized light beams are reflected by the first reflective polarized 130. For example, light of a second polarization P transmits through the first reflective polarizer 130 and then advances toward the polarization switch array 150. In 3D mode, the polarization switch areas 152 delay a phase of incident light to change a polarization direction of incident light into a direction orthogonal to the polarization direction of incident light. That is, the incident light of a second polarization P is changed into a light of a first polarization S passing through the polarization switch areas 152 of the polarization switch array 150 and enters the second reflective polarizer 170. On the other hand, a polarization direction of light passing the slit areas 154 of the polarization switch array 150 is not changed, and the light of a second polarization P is incident onto the second reflective polarizer 170 maintaining its polarization direction. Here, the second reflective polarizer 170 reflects the first polarized light beam S and transmits the second polarized light beam P. Thus, the second polarized light beam P having passed through the slit area 154 transmits through the second reflective polarizer 170 and then advances toward the display panel 190. However, the first polarized light beam S having passed the polarization switch areas 152 is reflected from the second reflective polarizer 170. In other words, when the polarization switch areas 152 are in an on state, the polarization switch areas 152 and the second reflective polarizer 170 split light into light beams which respectively advance toward the left eye pixels L and the right eye pixels R of the display panel 190. Thus, different images are incident into left and right eyes so that the left and right eyes perceive a 3D image. Light beams reflected from the first or second reflective polarizer 130 or 170 advance toward the light source unit 110 and are reflected by the reflector 115 so as to be recycled.

FIG. 7B illustrates an optical path through which the 2D/3D switchable display device 100 operates in the 2D. Referring to FIG. 7B, the polarization switch areas 152 are controlled so as not to delay the phase of the incident light. Thus, light beams passing through the polarization switch areas 152 and the slit areas 154 maintain the second polarization state, are incident onto the second reflective polarizer 170, and transmit through the second reflective polarizer 170. The same image reaches the left and right eyes without a binocular parallax so that the left and right eyes perceive a 2D image.

It has been described that first and second reflective polarizers reflect S polarized light and transmit P polarized light. However, this is exemplary, and thus reflective polarizers having opposite characteristics may be used. Also, it has been described that a two-view 3D image is formed using left and right eye images. However, a display panel may display a multiview image in each pixel to form a multiview 3D image.

As described above, a 2D/3D switchable display device according to the present invention can include a switching parallax barrier unit which is controlled in a 2D or 3D mode. The switching parallax barrier unit can transmit predetermined polarized light beams but reflect other polarized light beams so as to form a binocular parallax. Thus, when the 2D mode is switched to the 3D mode, a reduction of optical efficiency can be minimized. As a result, the sizes of the slits of the 2D/3D switchable display device can be minimized to reduce crosstalk. Also, the 2D/3D switchable display device can be applied in a multiview way.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A 2-dimensional (2D)/3-dimensional (3D) switchable display device comprising:
a first reflective polarizer which reflects first polarized light beams and transmits second polarized light beams orthogonal to the first polarized light beams among light beams irradiated from a light source unit;
a switching parallax barrier unit controlled in one of 2D or 3D modes,
wherein, in the 2D mode, the switching parallax barrier unit wholly transmits the light beams having passed the first reflective polarizer, and
wherein, in the 3D mode, an area of the switching parallax barrier unit transmits the light beams and an area of the switching parallax barrier unit intercepts the light beams; and
a display panel which modulates light, that is transmitted through the switching parallax barrier unit, according to an image signal, to form an image.

2. The 2D/3D switchable display device of claim 1, wherein the switching parallax barrier unit comprises:
a polarization switch array, comprising
polarization switch areas, which are controlled to switch the second polarized light beams, having passed through the first reflective polarizer, to the first polarized light beams, or, to maintain their polarization states, and
slit areas, which transmit the second polarized light beams maintaining their polarization states,
wherein the polarization switch areas and the slit areas are alternately arrayed; and
a second reflective polarizer which reflects the first polarized light beams and transmits the second polarized light beams.

3. The 2D/3D switchable display device of claim 2, wherein the polarization switch areas delay a phase of incident light having a wavelength λ by 0, +λ/2, or −λ/2 according to an electrical signal.

4. The 2D/3D switchable display device of claim 2, wherein the second reflective polarizer is a wire grid polarizer.

5. The 2D/3D switchable display device of claim 2, wherein the second reflective polarizer is a double brightness enhancement film (DBEF).

6. The 2D/3D switchable display device of claim 2, wherein the polarization switch array has polarization switch areas and slit areas.

7. The 2D/3D switchable display device of claim 2, wherein the polarization switch array has a strip shape in which the polarization switch areas and the slit areas are arrayed in a strip shape.

8. The 2D/3D switchable display device of claim 2, wherein the polarization switch array has a 2D arrayed shape in which the polarization switch areas and the slit areas are 2-dimensionally arrayed in zigzag.

9. The 2D/3D switchable display device of claim 2, wherein the polarization switch array has a pin hole shape in which the slit areas are pin holes.

10. The 2D/3D switchable display device of claim 1, wherein the light source unit comprises a reflector which recycles light reflected from one of the first and second reflective polarizers.

11. The 2D/3D switchable display device of claim 1, wherein the first reflective polarizer is a wire grid polarizer.

12. The 2D/3D switchable display device of claim 1, wherein the first reflective polarizer is a double brightness enhancement film (DBEF).
